(19) United States
(12) Patent Application Publication
(10) Pub. No.: US 2007/0061552 A1
(43) Pub. Date: Mar. 15, 2007

(54) Architecture of program address generation capable of executing wait and delay instructions

(76) Inventor: Jung Lin Chang, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,112

(22) Filed: Sep. 14, 2005

(51) Int. Cl. G06F 9/44

(52) U.S. Cl. 712/220

(57) ABSTRACT

An architecture of program address generation capable of executing a WAIT instruction and a DELAY instruction feeds the program address to the input terminal of a multiplexer to add a WAIT instruction to a program for performing a wait operation. This WAIT instruction can also be controlled by adding a clock gate unit. Besides, a DELAY instruction is used to feed the program address to the input terminal of the multiplexer, and an accumulator is used as a control mechanism of several clocks of delay. The proposed architecture of program address generation can make programs succinct and easy to compose, can effectively avoid repetitive execution of program, can precisely control the timing of program execution, and can reduce the response time of the program when some event occurs.

### BACKGROUND OF THE INVENTION

1. Field of the Invention

The present invention relates to the architecture of program address generation of a microcontroller and, more particularly, to a program address calculator architecture capable of executing a WAIT instruction and a DELAY instruction.

2. Description of Related Art

The most frequently used assembly language programs are executed one line after another such as:

| | | |
|---|---|---|
| move | ax, | 0x00; |
| move | bx, | 0x02; |
| add | ax, | bx; |

Under some conditions, some loops occur such as:

| | | |
|---|---|---|
| | move | ax, 0x20; |
| loop1: | sub | ax, 1; |
| | jnz | loop1; |
| | nop; | |

or

| | |
|---|---|
| move | cx, 0x20; |

| | move | ax, 0x30; |
|---|---|---|
| loop2: | sub | ax, 1; |

| | |
|---|---|
| loopnz | loop2; |
| nop; | |

The above program statements are basic syntaxes widely used by programmers.

The conventionally used architecture of program address generation is shown in FIG. 1, in which a multiplexer 12 receives a select-signal from a program sequencer 10, selects a corresponding program address among input signals as the next program address, and transfers it to program address register 14 as the program address for the next instruction cycle. During the execution of program, every instruction is executed once, then, the multiplexer 12 selects the next instruction for execution. If there is a loop operation, either some instructions will be used or extra hardware will be added to check whether a certain specific condition occurs or not. The most common way is to add one or several counter registers to store the number of times of the loop. The program sequencer 10 makes use of the result of the counter registers to decide the next instruction for execution. This way of instruction execution, however, has the following disadvantages: (1) After execution of every instruction, the next instruction is immediately executed. If some signals or events are awaited to happen, it is necessary to add some extra instructions—some will check whether the condition happens, some will allow the process to jump back to the start of the original program so as to run the loop for checking; (2) Because the instructions for checking is only part of the loop program, the time point of the occurrence of event may be in any instruction of the loop program. The microcontroller therefore cannot precisely detect the time point of the occurrence of event. In addition to delaying the response time to the occurrence of event, the accuracy of timing capture is greatly reduced, too; (3) If the program is used for timing delay, some redundant procedures will be executed, and it is necessary to reload the counter and then execute the loop program. If the delay time is not exactly integer of the execution time of the loop, it is needed to add some dummy codes, hence lengthening the program codes. When the system needs to execute the delay program, the execution of these dummy codes will increase; (4) The loop counter uses extra counter registers and logic circuits, there will be extra hardware cost.

Accordingly, the present invention proposes an architecture of program address generation capable of executing a WAIT instruction and a DELAY instruction to avoid the disadvantages occurred due to execution of loop check, thereby making the program more succinct and simplifying the use of microcontroller registers. Moreover, programs will be exactly executed according to the required timing.

### SUMMARY OF THE INVENTION

An object of the present invention is to provide an architecture of program address generation capable of executing a WAIT instruction and a DELAY instruction so that a program can use the WAIT instruction to await change of peripheral signals without the need of a loop program for checking the occurrence of a certain signal or state. Therefore, the program design can be simplified, and the response time of the program for change of peripheral signals can be reduced.

Another object of the present invention is to provide an architecture of program address generation capable of executing a WAIT instruction and a DELAY instruction so that a program can use the DELAY instruction to set the required delay time without the need of a loop program for progressively decreasing or comparing a certain set value. Dummy codes can therefore be avoided in the program code, and the timing of program can be precisely controlled.

Another object of the present invention is to provide an architecture of program address generation capable of executing a WAIT instruction and a DELAY instruction so as to reduce the program code and allow programmers to easily use one instruction to finish a function that otherwise requires several instructions in the conventional architecture.

To achieve the above objects, an architecture of program address generation capable of executing a WAIT instruction of the present invention comprises a program sequencer, a multiplexer, and a program address register. The program sequencer receives a first set of signals and outputs a select-signal among the first set of signals after judgement. The multiplexer is connected to the program sequencer, and receives the select-signal outputted by the program sequencer. The multiplexer also receives a second set of signals and selects a signal output among the second set of signals as a next program address according to the select-signal. The program address register is connected to the multiplexer to receive the next program address and output a program address. The program address register also has a circuit capable of transferring the program address back to an input terminal of the multiplexer as a signal in the second set of signals.

To achieve the above objects, an architecture of program address generation capable of executing a WAIT instruction of the present invention comprises a program sequencer, a clock gate unit, a multiplexer, and a program address register. The program sequencer receives a first set of signals and outputs a select-signal among the first set of signals after judgement. The clock gate unit is connected to the program sequencer to receive the select-signal. The clock gate unit also receives a clock signal and finally outputs a timing-control-signal. The multiplexer is connected to the program sequencer to receive the select-signal. The multiplexer also receives a second set of signals and selects a signal output among the second set of signals as a next program address. The program address register is connected to the clock gate unit to receive the timing-control-signal. The program address register is also connected to the multiplexer to receive the next program address, and finally outputs a program address according to the timing-control-signal.

To achieve the above objects, an architecture of program address generation capable of executing a DELAY instruction of the present invention comprises an accumulator, an arithmetic logic unit (ALU), a program sequencer, a multiplexer, and a program address register. The accumulator receives an instruction, outputs a numeral-signal, and receives a progressive-decrease-result. The ALU receives the numeral-signal of the accumulator, decreases the numeral-signal by a value, and then outputs the progressive-decrease-result and a delay-end-signal. The program sequencer is connected to the ALU to receive the delay-end-signal. The program sequencer also receives a first set of signals and outputs a select-signal among the first set of signals after judgement. The multiplexer is connected to the program sequencer to receive the select-signal outputted by the program sequencer. The multiplexer also receives a second set of signals and selects a signal output as a next program address among the second set of signals according to the select-signal. The program address register is connected to the multiplexer to receive the next program address. The program address register also has a circuit capable of transferring the next program address back to an input terminal of the multiplexer as a signal in the second set of signals.

To achieve the above objects, an architecture of program address generation capable of executing a DELAY instruction of the present invention comprises an accumulator, an ALU, a program sequencer, a clock gate unit, a multiplexer, and a program address register. The accumulator receives an instruction, outputs a numeral-signal, and also receives a progressive-decrease-result outputted by the ALU. The ALU receives the numeral-signal of the accumulator, decreases the numeral-signal by a value, and then outputs the progressive-decrease-result to the accumulator and a delay-end-signal to the program sequencer. The program sequencer is connected to the ALU to receive the delay-end-signal. The program sequencer also receives a first set of signals and outputs a select-signal among the first set of signals after judgement. The clock gate unit is connected to the program sequencer to receive the select-signal. The clock gate unit also receives a clock signal and finally outputs a timing-control-signal. The multiplexer is connected to the program sequencer to receive the select-signal outputted by the program sequencer. The multiplexer also receives a second set of signals and selects a signal output among the second set of signals as a next program address according to the select-signal. The program address register is connected to the clock gate unit to receive the timing-control-signal. The program address register is also connected to the multiplexer to receive the next program address. The program address register finally determines whether to use the next program address as a new program address according to the timing-control-signal.

### BRIEF DESCRIPTION OF THE DRAWINGS

The various objects and advantages of the present invention will be more readily understood from the following detailed description when read in conjunction with the appended drawing, in which:

FIG. 1 is an architecture of program address generation in the prior art;

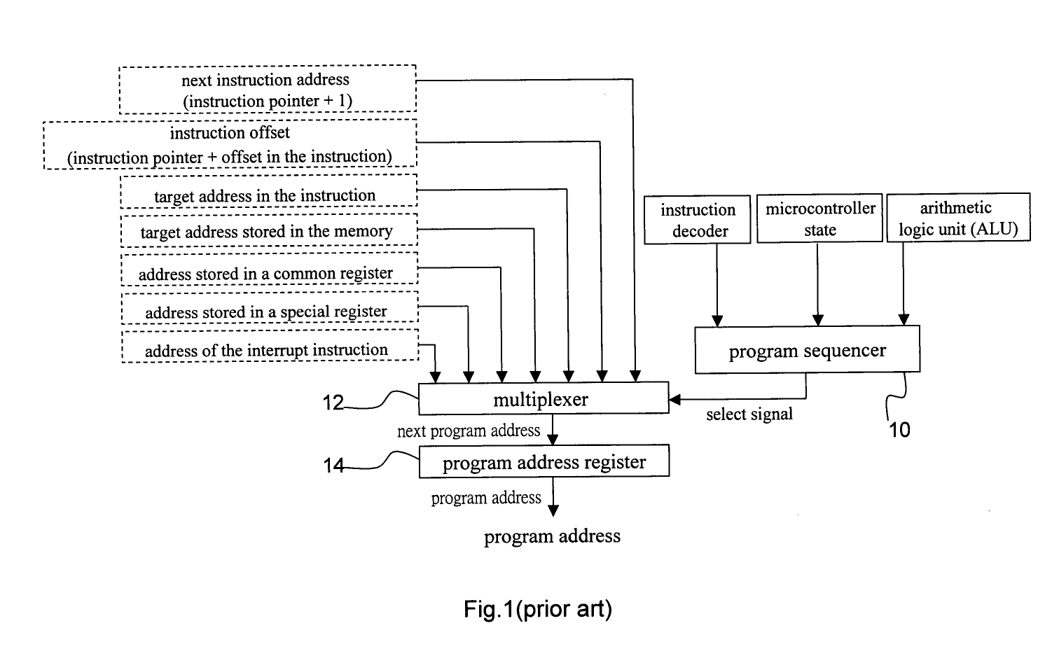

FIG. 2 is an architecture of program address generation capable of executing a WAIT instruction of the present invention;

FIG. 3 is an architecture of program address generation of executing a WAIT instruction according to another embodiment of the present invention;

FIG. 4 is an architecture of program address generation capable of executing a DELAY instruction of the present invention; and

FIG. 5 is an architecture of program address generation capable of executing a DELAY instruction according to another embodiment of the present invention.

### DETAILED DESCRIPTION OF THE PREFERRED EMBODIMENTS

The present invention makes use of a microcontroller architecture to execute a WAIT instruction and a DELAY instruction. In the expression of program language, words are used as commands to express instruction execution in a program. This microcontroller architecture allows a program to precisely control the execution timing of microcontroller, simplifies program design, and prevents from repetitively executing a loop program to await the occurrence of a certain event.

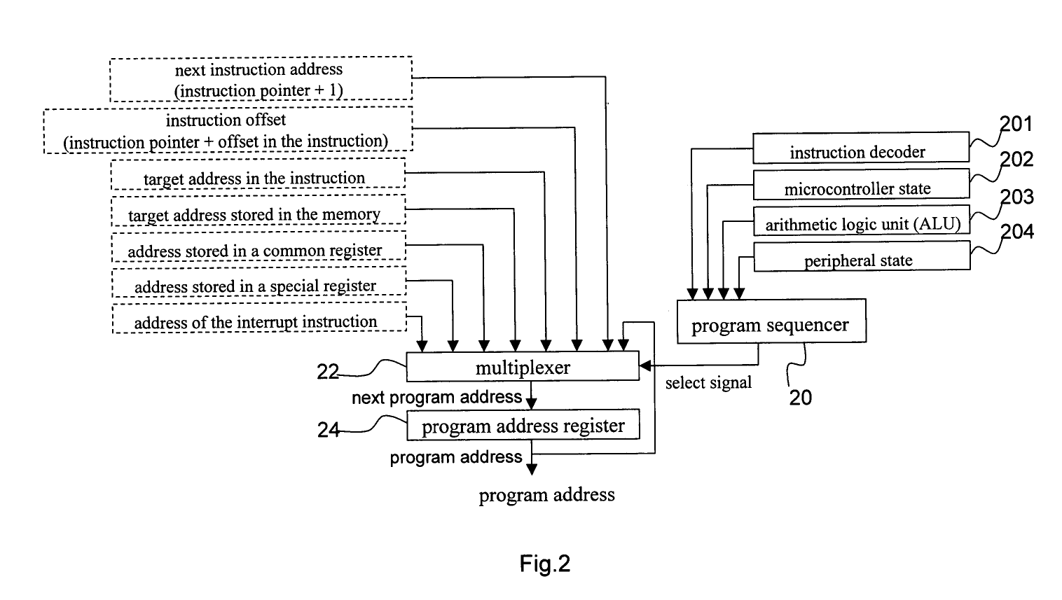

FIG. 2 is an architecture of program address generation capable of executing a WAIT instruction of the present invention, which comprises a program sequencer 20, a multiplexer 22, and a program address register 24. The program sequencer 20 receives several signals and outputs a select-signal from the received signals accordingly. The multiplexer 22 is connected to the program sequencer 20, and receives the select-signal outputted by the program sequencer 20. The multiplexer 22 also receives several signals and selects a signal output among the received signals as the next program address according to the select-signal. The program address register 24 is connected to the multiplexer 22 to receive the next program address, and outputs a program address for the microcontroller to execute the program. The program address register 24 also has a circuit capable of transferring the program address back to an input terminal of the multiplexer 22 as an input signal of the multiplexer 22.

The input signals of the program sequencer 20 are the output signals of several circuit units, including an instructions decoder 201, a microcontroller status 202, an ALU 203, and a waiting-device (represented as a peripheral 204 for simplicity). The waiting-device can be a signal of the peripheral 204, an external input clock, a register's content, or a memory's content. The input signals of the multiplexer 22 include the select-signal, an address for the next instruction (program address+1), an address with instruction offset (program address+offset in the instruction), an address in the instruction, an address stored in the memory, an address stored in the general register, an address stored in the special register, and address for the interrupt.

When the above architecture is employed, a “WAIT” or a word or a symbol having the equivalent function can be added in the program language to execute the function of awaiting signal change of the peripheral. The program sequencer 20 outputs a select-signal to the multiplexer 22 after judgement from the input signals accordingly, and the multiplexer then selects a signal output among the received signals as the next program address according to the select-signal. The following program codes show how to await the input signal IO.7 (bit 7 of the IO port) of a peripheral device to change from “0” to “1”:

WAIT1 IO.7;

a=b+c

When the instruction “WAIT1 IO.7” is executed, the program sequencer 20 will select “a=b+c” for the next instruction to be executed if IO.7 is “1” (i.e., program address+1). Before IO.7 changes from “0” to “1”, the program sequencer 20 will select the program address which feeds back to the multiplexer 22 from the program address register 24 as the next program address. As long as the awaited event does not happen, the execution of program will stay at “WAIT1 IO.7” instruction. This will make program written more easily, make programs more succinct, and also reduce the response time of the occurrence of event.

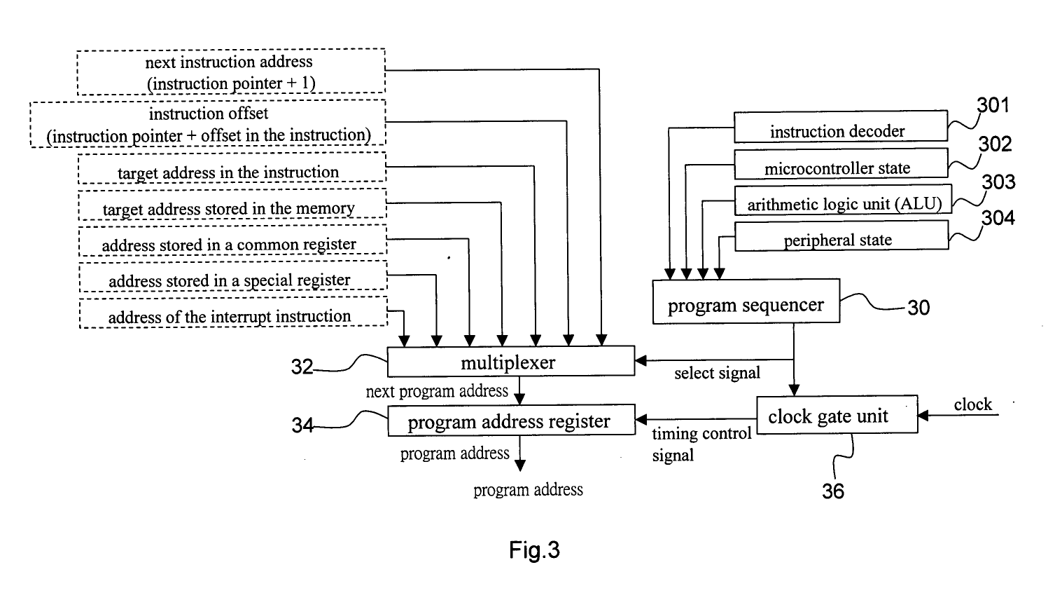

FIG. 3 is an architecture of program address generation capable of executing a WAIT instruction according to another embodiment of the present invention, which comprises a program sequencer 30, a clock gate unit 36, a multiplexer 32, and a program address register 34. The program sequencer 30 receives several signals and outputs a select-signal by the received signals accordingly. The clock gate unit 36 is connected to the program sequencer 30 to receive the select-signal. The clock gate unit also receives a clock signal and finally outputs a timing-control-signal. The multiplexer 32 is connected to the program sequencer 30 to receive the select-signal outputted by the program sequencer 30. The multiplexer also receives several signals and selects a signal output among the received signals as a next program address. The program address register 34 is connected to the clock gate unit 36 to receive the timing-control-signal. The program address register 34 is also connected to the multiplexer 32 to receive the next program address. The program address register 34 then determines whether to use the next program address outputted by the multiplexer 32 or the original program address as the new program address according to the timing-control-signal.

The input signals of the program sequencer 30 are output signals of several circuit units, including an instructions decoder 301, a microcontroller status 302, an ALU 303, and a waiting-device (represented as a peripheral 304 for simplicity). The waiting-device can be is a signal of the peripheral 304, an external input clock, a register's content, or a memory's content. The input signals of the multiplexer 32 include the select-signal, an address for the next instruction (program address+1), an address with instruction offset (program address+offset in the instruction), an address in the instruction, an address stored in the memory, an address stored in the general register, an address stored in the special register, and address for the interrupt.

Based on the above architecture, when a WAIT instruction is used, the program can be kept at the state of awaiting the occurrence of a certain event. Once the awaited event happens (e.g., IO.7 changes from “0” to “1”), the following instruction is executed. The event can be a signal of the peripheral 304, an external input clock, a register's content, or a memory's content.

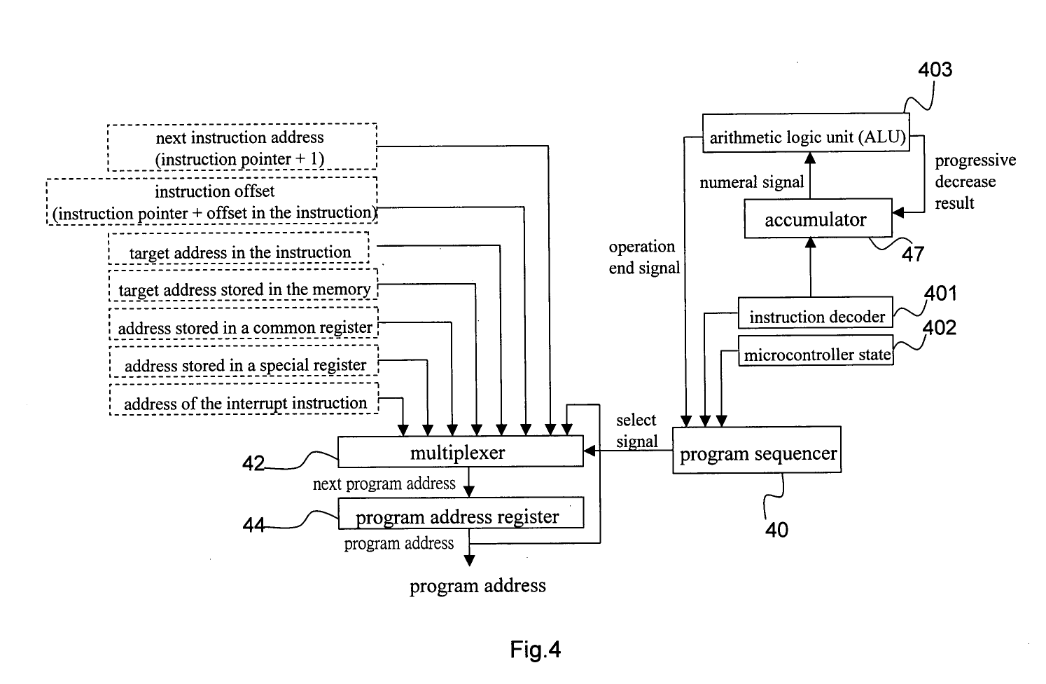

FIG. 4 is an architecture of program address generation capable of executing a DELAY instruction of the present invention, which comprises an accumulator 47, an ALU 403, a program sequencer 40, a multiplexer 42, and a program address register 44. The ALU 403 receives a numeral-signal, decreases the numeral-signal by a value, and then outputs the progressive-decrease-result to the accumulator 47 and a delay-end-signal to the program sequencer 40. The accumulator 47 is connected to the ALU 403 and an instructions decoder 401. The accumulator 47 receives a DELAY command from the instructions decoder 401, outputs a numeral-signal to the ALU 403, and receives a progressive-decrease-result outputted by the ALU 403. The program sequencer 40 is connected to the ALU 403 to receive the delay-end-signal. The program sequencer 40 also receives several signals and outputs a select-signal after judgement by the received signals accordingly. The multiplexer 42 is connected to the program sequencer 40 to receive the select-signal outputted by the program sequencer 40. The multiplexer 42 also receives several signals and selects a signal output among the received signals as a next program address according to the select-signal. The program address register 44 is connected to the multiplexer 42 to receive the next program address, and outputs a program address. The program address register 44 also has a circuit capable of transferring the program address back to an input terminal of the multiplexer 42 as an input signal of the multiplexer 42.

The input signals of the program sequencer 40 are output signals of several circuit units, including the instructions decoder 401, a microcontroller status 402, and the ALU 403. The input signals of the multiplexer 42 include the select-signal, an address for the next instruction (program address+1), an address with instruction offset (program address+offset in the instruction), an address in the instruction, an address stored in the memory, an address stored in the general register, an address stored in the special register, and address for the interrupt.

Based on the above architecture, it is only necessary to use a DELAY instruction to execute the function of delaying program codes in the program language. The DELAY instruction is used to delay several clocks. For instance, the following program codes:

Assign A=100; //A is accumulator

DELAY A;

C=E+F;

The program will stay at the program address of the instruction “DELAY A” for 100 clocks of the microcontroller and then execute the instruction “C=E+F”.

One can use different numerals in the program to delay for different clocks. When the DELAY instruction is executed and the value in the accumulator 47 is not 0, the delay-end-signal will inform the program sequencer 40 and let the multiplexer 42 choose the program address outputted by the program address register 44 as the next program address. Once the value in the accumulator 47 is progressively decreased to 0, the delay-end-signal will inform the program sequencer 40 and let the multiplexer 42 to choose the next new instruction (i.e., C=E+F).

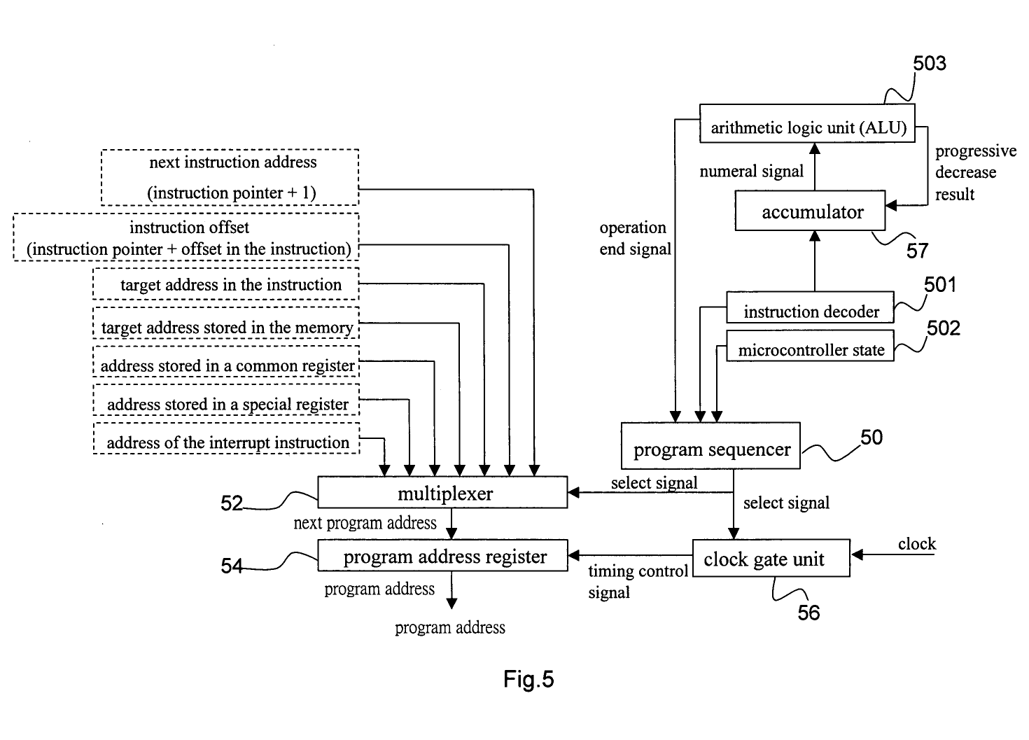

FIG. 5 is an architecture of program address generation capable of executing a DELAY instruction according to another embodiment of the present invention, which comprises an accumulator 57, an ALU 503, a program sequencer 50, a clock gate unit 56, a multiplexer 52, and a program address register 54. The accumulator 57 receives an instruction, outputs a numeral-signal, and also receives a progressive-decrease-result outputted by the ALU 503. The ALU 503 receives the numeral-signal of the accumulator, decreases the numeral-signal by a value, and then outputs the progressive-decrease-result to the accumulator 57 and a delay-end-signal to the program sequencer 50. The program sequencer 50 is connected to the ALU 503 to receive the delay-end-signal. The program sequencer 50 also receives output signals of several circuit units and outputs a select-signal among the received signals after judgement. The clock gate unit 56 is connected to the program sequencer 50 to receive the select-signal. The clock gate unit 56 also receives a clock signal and finally outputs a timing-control-signal. The multiplexer 52 is connected to the program sequencer 50 to receive the select-signal outputted by the program sequencer 50. The multiplexer 52 also receives several signals and selects a signal output among the received signals as a next program address according to the select-signal. The program address register 54 is connected to the clock gate unit 56 to receive the timing-control-signal. The program address register 54 is also connected to the multiplexer 52 to receive the next program address. The program address register finally determines whether to use the next program address as a new program address or the original program address as the new program address according to the timing-control-signal.

The circuit units include an instructions decoder 501, a microcontroller status 502, and the ALU 503. The input signals of the multiplexer 52 include the select-signal, an address for the next instruction (program address+1), an address with instruction offset (program address+offset in the instruction), an address in the instruction, an address stored in the memory, an address stored in the general register, an address stored in the special register, and an address for the interrupt.

When the above architecture is employed, a “DELAY” or a word or a symbol having the equivalent function can be added in the program language to execute the function of delaying program codes for some clocks.

To sum up, the present invention makes use of the above microcontroller architectures to make programs more succinct. Besides, programmers can be prevented from using a loop for controlling the timing of program execution and the time delay.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An architecture of program address generation capable of executing a WAIT instruction making use of a word as a command to express instruction execution in a program, said architecture of program address generation comprising:
a program sequencer for receiving a first set of signals and outputting a select-signal among said first set of signals after judgement;
a multiplexer connected to said program sequencer to receive said select-signal outputted by said program sequencer, said multiplexer also receiving a second set of signals and selecting a signal output among said second set of signals as a next program address according to said select-signal; and
a program address register connected to said multiplexer to receive said next program address and output a program address, said program address register also having a circuit capable of transferring said program address back to an input terminal of said multiplexer as a signal in said second set of signals.

2. The architecture of program address generation capable of executing a WAIT instruction as claimed in claim 1, wherein said first set of signals includes signals outputted by several circuit units.

3. The architecture of program address generation capable of executing a WAIT instruction as claimed in claim 2, wherein said circuit units include an instructions decoder, a microcontroller status, an arithmetic logic unit, and a waiting-device.

4. The architecture of program address generation capable of executing a WAIT instruction as claimed in claim 3, wherein said waiting-device is a signal of a peripheral, an external input clock, a register's content, or a memory's content.

5. The architecture of program address generation capable of executing a WAIT instruction as claimed in claim 1, wherein said second set of signals includes said program address, an address for the next instruction, an address with instruction offset, an address in the instruction, an address stored in the memory, an address stored in the general register, an address stored in the special register, and an address for the interrupt.

6. The architecture of program address generation capable of executing a WAIT instruction as claimed in claim 1, wherein said word is “WAIT”.

7. An architecture of program address generation capable of executing a WAIT instruction making use of a word as a command to express instruction execution in a program, said architecture of program address generation comprising:
a program sequencer for receiving a first set of signals and outputting a select-signal among said first set of signals after judgement;
a clock gate unit connected to said program sequencer to receive said select-signal, said clock gate unit also receiving a clock signal and outputting a timing-control-signal;
a multiplexer for receiving a second set of signals and selecting a signal output among said second set of signals as a next program address; and
a program address register connected to said clock gate unit to receive said timing-control-signal, said program address register being also connected to said multiplexer to receive said next program address, said program address register outputting a program address according to said timing-control-signal.

8. The architecture of program address generation capable of executing a WAIT instruction as claimed in claim 7, wherein said first set of signals includes signals outputted by several circuit units.

9. The architecture of program address generation capable of executing a WAIT instruction as claimed in claim 8, wherein said circuit units include an instructions decoder, a microcontroller status, an arithmetic logic unit, and a waiting-device.

10. The architecture of program address generation capable of executing a WAIT instruction as claimed in claim 9, wherein said waiting-device is a signal of a peripheral, an external input clock, a register's content, or a memory's content.

11. The architecture of program address generation capable of executing a WAIT instruction as claimed in claim 7, wherein said second set of signals includes said program address, an address for the next instruction, an address with instruction offset, an address in the instruction, an address stored in the memory, an address stored in the general register, an address stored in the special register, and an address for the interrupt.

12. The architecture of program address generation capable of executing a WAIT instruction as claimed in claim 7, wherein said word is “WAIT”.

13. An architecture of program address generation capable of executing a DELAY instruction making use of a word as a command to express instruction execution in a program, said architecture of program address generation comprising:
an accumulator for receiving an instruction and outputting a numeral-signal and receiving a progressive-decrease-result;
an arithmetic logic unit for receiving said numeral-signal of said accumulator, decreasing said numeral-signal by a value, and then outputting said progressive-decrease-result and a delay-end-signal;
a program sequencer connected to said arithmetic logic unit to receive said delay-end-signal, said program sequencer also receiving a first set of signals and outputting a select-signal among said first set of signals after judgement;
a multiplexer connected to said program sequencer to receive said select-signal outputted by said program sequencer, said multiplexer also receiving a second set of signals and selecting a signal output among said second set of signals as a next program address according to said select-signal; and
a program address register connected to said multiplexer to receive said next program address, said program address register being used to output a program address, said program address register also having a circuit capable of transferring said program address back to an input terminal of said multiplexer as a signal in said second set of signals.

14. The architecture of program address generation of executing a DELAY instruction as claimed in claim 13, wherein said accumulator can be a register.

15. The architecture of program address generation capable of executing a DELAY instruction as claimed in claim 13, wherein said first set of signals includes signals outputted by several circuit units.

16. The architecture of program address generation capable of executing a DELAY instruction as claimed in claim 15, wherein said circuit units include an instructions decoder, a microcontroller status, and an arithmetic logic unit.

17. The architecture of program address generation capable of executing a DELAY instruction as claimed in claim 13, wherein said second set of signals includes said program address, an address for the next instruction, an address with instruction offset, an address in the instruction, an address stored in the memory, an address stored in the general register, an address stored in the special register, and an address for the interrupt.

18. The architecture of program address generation capable of executing a DELAY instruction as claimed in claim 13, wherein said word is “DELAY”.

19. An architecture of program address generation capable of executing a DELAY instruction making use of a word as a command to express instruction execution in a program, said architecture of program address generation comprising:
an accumulator for receiving an instruction, outputting a numeral-signal, and receiving a progressive-decrease-result;
an arithmetic logic unit for receiving said numeral-signal of said accumulator, decreasing said numeral-signal by a value, and then outputting said progressive-decrease-result and a delay-end-signal;
a program sequencer connected to said arithmetic logic unit to receive said delay-end-signal, said program sequencer also receiving a first set of signals and outputting a select-signal among said first set of signals after judgement;
a clock gate unit connected to said program sequencer to receive said select-signal, said clock gate unit also receiving a clock signal and finally outputting a timing-control-signal;
a multiplexer connected to said program sequencer to receive said select-signal outputted by said program sequencer, said multiplexer also receiving a second set of signals and selecting a signal output among said second set of signals as a next program address according to said select-signal; and
a program address register connected to said clock gate unit to receive said timing-control-signal, said program address register being also connected to said multiplexer to receive said next program address, said program address register finally determining whether to use said next program address as a new program address according to said timing-control-signal.

20. The architecture of program address generation capable of executing a DELAY instruction as claimed in claim 19, wherein said accumulator can be a register.

21. The program address calculator architecture capable of executing a DELAY instruction as claimed in claim 19, wherein said first set of signals includes signals outputted by several circuit units.

22. The architecture of program address generation capable of executing a DELAY instruction as claimed in claim 21, wherein said circuit units include an instructions decoder, a microcontroller status, and an arithmetic logic unit.

23. The architecture of program address generation capable of executing a DELAY instruction as claimed in claim 19, wherein said second set of signals includes said program address, an address for the next instruction, an address with instruction offset, an address in the instruction, an address stored in the memory, an address stored in the general register, an address stored in the special register, and an address for the interrupt.

24. The architecture of program address generation capable of executing a DELAY instruction as claimed in claim 19, wherein said word is “DELAY”.
